(19) United States
(12) Patent Application Publication
(10) Pub. No.: US 2026/0332882 A1
(43) Pub. Date: Oct. 22, 2026

(54) ELECTRONIC DEVICE

(71) Applicant: CANON KABUSHIKI KAISHA, Tokyo (JP)

(72) Inventor: RIHO SATOYOSHI, Tokyo (JP)

(21) Appl. No.: 19/560,552

(22) Filed: Mar. 9, 2026

(30) Foreign Application Priority Data
Apr. 22, 2025 (JP) 2025-070117

(51) Int. Cl. H04N 23/63; G06F 3/04845

(52) U.S. Cl. CPC H04N 23/632; G06F 3/04845; H04N 23/634; H04N 23/635

(57) ABSTRACT

An electronic device according to the present disclosure includes a processor, and a memory storing a program which, when executed by the processor, causes the electronic device to execute display control processing of performing control to display a crop frame indicating a crop area, which is an area to be cut out from an image, by superimposing the crop frame on the image, wherein, in the display control processing, control is executable to perform enlarged display of enlarging and displaying an enlarged area, which is a partial area of the image, and control is performed to display a first indicator indicating a direction toward the crop area during the enlarged display.

### BACKGROUND

### Field of the Technology

The present disclosure relates to an electronic device, and more particularly to a technique for performing both crop frame display and enlarged display.

### Description of the Related Art

As a function of an imaging device, a crop function of setting a crop area which is an area cut out (extracted) from a captured image and cutting out the crop area from the captured image has been proposed. In the crop function, the image of the cut-out crop area can be displayed on a display device or saved in a recording medium. Further, in the crop function, a crop frame indicating the crop area can be superimposed on the captured image and displayed on the display device.

As a function of the imaging device, an enlarged display function of enlarging and displaying a part of the captured image has also been proposed. The enlarged display function is used, for example, to confirm whether an object is in focus at the time of shooting (recording).

Japanese Patent Laid-Open No. 2019-165299 discloses a technique for displaying an indicator indicating a movable range of a focus guide during enlarged display. When a user uses the crop function, it is assumed that the enlarged display function is used to confirm the focus in the crop area. Therefore, it is preferable to display the crop frame during enlarged display.

When a part of the captured image is enlarged and displayed by the enlarged display function in a state in which the crop frame is displayed, the crop frame may not be displayed or only a part of the crop frame may be displayed. In this case, the user takes time to find the crop frame (crop area) or misunderstands the crop area, so that the focus in the crop area cannot be smoothly confirmed.

### SUMMARY

The present disclosure provides a technique that enables a user to quickly and accurately find a crop area.

An electronic device according to the present disclosure includes a processor, and a memory storing a program which, when executed by the processor, causes the electronic device to execute display control processing of performing control to display a crop frame indicating a crop area, which is an area to be cut out from an image, by superimposing the crop frame on the image, wherein, in the display control processing, control is executable to perform enlarged display of enlarging and displaying an enlarged area, which is a partial area of the image, and control is performed to display a first indicator indicating a direction toward the crop area during the enlarged display.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram of a digital camera.

FIG. 2 is a schematic diagram of a display screen.

FIGS. 3A and 3B are schematic diagrams of the display screen.

FIGS. 4A and 4B are schematic diagrams of the display screen.

FIGS. 5A-5H are schematic diagrams of the display screen.

FIGS. 6A and 6B are schematic diagrams of the display screen.

FIGS. 7A-7F are schematic diagrams of the display screen.

FIG. 8 is a flowchart of the digital camera.

### DESCRIPTION OF THE EMBODIMENTS

Hereinafter, embodiments of the present disclosure will be described with reference to the drawings. In the present embodiment, the present disclosure is applied to a digital camera.

### Hardware Configuration

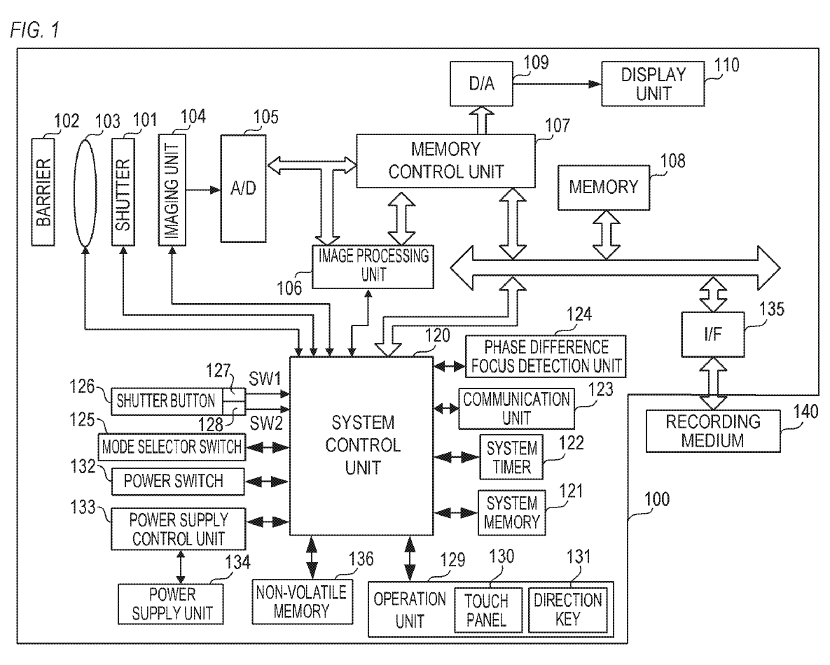

FIG. 1 is a block diagram illustrating a configuration of a digital camera 100 according to the present embodiment.

A shooting lens 103 is a lens group including a zoom lens and a focus lens. A shutter 101 is a shutter having an aperture function. An imaging unit 104 is an imaging element including a CMOS element or the like that converts an object image into an electrical signal. The imaging unit 104 includes pixels capable of detecting a defocus amount as a part of pixels, that is, phase difference detection pixels, and can perform image-plane phase-difference AF. Specifically, the imaging unit 104 includes a plurality of shooting pixels each receiving a light flux passing through the entire area of an exit pupil of a shooting optical system and generating an object image. Furthermore, the imaging unit 104 includes a plurality of phase difference detection pixels each receiving a light flux passing through a different area of the exit pupil of the shooting optical system. The plurality of phase difference detection pixels can receive a light flux passing through the entire area of the exit pupil of the shooting optical system as a whole. An A/D converter 105 converts an analog signal output from the imaging unit 104 into a digital signal. A barrier 102 covers an imaging system including the shooting lens 103, the shutter 101, and the imaging unit 104, thereby preventing contamination or damage of the imaging system.

An image processing unit 106 performs resizing processing such as predetermined pixel interpolation and reduction, color conversion processing, and the like on image data from the A/D converter 105 or image data from a memory control unit 107. The image processing unit 106 performs a predetermined calculation processing using the shot image data, and performs, based on the result of calculation, TTL automatic white balance (AWB) processing. In addition, the image processing unit 106 performs predetermined calculation processing using the shot image data, and the system control unit 120 performs, based on the result of calculation, exposure control and distance measurement control. Specifically, the system control unit 120 performs, based on the result of calculation, AF processing such as image-plane phase-difference AF and contrast AF, auto exposure (AE) processing, and flash preliminary emission (EF) processing. The image-plane phase-difference AF is performed by a phase difference focus detection unit 124 configured to perform focus detection based on an instruction from a system control unit 120.

The image data from the A/D converter 105 is written into a memory 108 via the image processing unit 106 and the memory control unit 107 or via the memory control unit 107 without the image processing unit 106. The memory 108 stores image data that is obtained by the imaging unit 104 and is converted into digital data by the A/D converter 105 and image data to be displayed on a display unit 110. The memory 108 has a storage capacity sufficient to store a predetermined number of still images, a moving image for a predetermined period of time, and a sound. The memory 108 also serves as a memory (video memory) for image display. A D/A converter 109 converts image data that is to be displayed and is stored in the memory 108 into an analog signal and supplies the analog signal to the display unit 110. Therefore, the image data for display written into the memory 108 is displayed by the display unit 110 via the D/A converter 109. The display unit 110 performs display according to an analog signal from the D/A converter 109 on a display such as an LCD. A digital signal once A/D converted by the A/D converter 105 and accumulated in the memory 108 is analog-converted by the D/A converter 109 and sequentially transferred to the display unit 110, whereby a live view image can be displayed.

A non-volatile memory 136 is an electrically erasable/recordable recording medium, and is, for example, an EEPROM or the like. In the non-volatile memory 136, constants, programs, threshold values, and the like for an operation of the system control unit 120 are stored. The program stored in the non-volatile memory 136 is a program to be executed by the system control unit 120. In addition, the non-volatile memory 136 stores a set value of a menu for the system control unit 120 to operate, and the set value of the menu can be updated by a user's operation.

The system control unit 120 can control the entirety of the digital camera 100. The system control unit 120 executes the program stored in the non-volatile memory 136 to implement processing of each flowchart to be described later. For example, the system control unit 120 changes a range in which focus detection can be performed by the phase difference focus detection unit 124, or notifies the user of the range.

A system memory 121 is, for example, a RAM, and constants and variables for the operation of the system control unit 120, programs read from the non-volatile memory 136, and the like are loaded in the system memory 121. Furthermore, the system control unit 120 performs display control by controlling the memory 108, the D/A converter 109, the display unit 110, or the like.

A system timer 122 is a timer unit that counts time used for various controls and time of an embedded clock. For example, the system control unit 120 determines whether a predetermined time has elapsed using the system timer 122.

A communication unit 123 transmits and receives a video signal and a voice signal to and from an external device connected wirelessly or via a wired cable. The communication unit 123 can also be connected to a wireless local area network (LAN) and the Internet. The communication unit 123 can transmit an image (including a live view image) captured by the imaging unit 104 and an image recorded in a recording medium 140, and can receive image data and other various types of information from an external device.

The phase difference focus detection unit 124 performs focus detection by using output signals of a plurality of phase difference detection pixels discretely arranged on the entire surface in a part of the imaging unit 104 or in a part of the imaging unit 104, thereby performing image-plane phase-difference AF.

A mode selector switch 125, a shutter button 126 (a first shutter switch 127 and a second shutter switch 128), and an operation unit 129 are used to input various operation instructions to the system control unit 120.

The mode selector switch 125 can switch the operation mode of the system control unit 120 to any of a still image recording mode, a moving image recording mode, a reproduction mode, and the like. The mode included in the still image recording mode includes an automatic shooting mode, an automatic scene determination mode, a manual mode, various scene modes as shooting modes for different shooting scenes, a program AE mode, a custom mode, and the like. For example, the mode can be directly switched to any of the above-described modes included in the still image shooting mode via the mode selector switch 125. Alternatively, after the mode is once switched to the still image shooting mode by the mode selector switch 125, the mode may be switched to any of the above-described modes included in the still image shooting mode by using another operation member. Similarly, the moving image shooting mode may include a plurality of modes.

The shutter button 126 is a button for instructing the system control unit 120 from the user to perform shooting preparation or shooting, and includes the first shutter switch 127 and the second shutter switch 128. The first shutter switch 127 is turned on in the middle of the operation of the shutter button 126, that is, by so-called half-pressing (shooting preparation instruction), and generates a first shutter switch signal SW1. The system control unit 120 starts an operation of shooting preparation processing including AF processing, AE processing, AWB processing, EF processing, and the like by the first shutter switch signal SW1. The second shutter switch 128 is turned on at the completion of the operation of the shutter button 126 that is, by so-called full-pressing (shooting instruction) and generates a second shutter switch signal SW2. The system control unit 120 starts a series of shooting processing operations from reading of a signal from the imaging unit 104 to writing of image data into the recording medium 140 by the second shutter switch signal SW2.

Each operation member of the operation unit 129 is appropriately assigned a function for each scene by selecting and operating various function icons displayed on the display unit 110, and acts as various function buttons. Examples of the function buttons include a menu button, a return button, a function call button, a setting switching button, an aperture preview button, and an attribute change button. For example, when the menu button is pressed, a menu screen on which various settings can be made is displayed on the display unit 110. The user can intuitively perform various settings using the menu screen displayed on the display unit 110, up, down, left, and right buttons, and a SET button.

A touch panel 130 is an operation member included in the operation unit 129. By associating the input coordinates on the touch panel 130 with the display coordinates on the display unit 110, it is possible to configure a GUI such that the user can directly operate the screen displayed on the display unit 110. The system control unit 120 receives input coordinates from the touch panel 130, and moves a cursor in upward, downward, leftward, and rightward directions or moves a frame related to focus.

A direction key 131 is an operation member included in the operation unit 129. The system control unit 120 receives an input signal from the direction key 131, and moves an enlarged area and a crop area in the vertical and horizontal directions.

A power switch 132 is a push button for switching between power-on and power-off. In addition, the power switch 132 may be a lever that switches power on and power off depending on the position thereof. A power supply control unit 133 includes a battery detection circuit, a DC-DC converter, a switch circuit that switches a block to be energized, and the like, and detects whether a battery is mounted, a type of battery, and a remaining battery level. In addition, the power supply control unit 133 controls the DC-DC converter based on the detection result and the instruction from the system control unit 120 and supplies a required voltage to each unit including the recording medium 140 for a necessary period of time. A power supply unit 134 is a primary battery such as an alkaline battery or a lithium battery, a secondary battery such as a NiCd battery, a NiMH battery, or a Li battery, or an AC adapter.

The recording medium I/F 135 is an interface with the recording medium 140. The recording medium 140 is a detachable memory card including a semiconductor memory, a magnetic disk, or the like. The recording medium I/F 135 records captured image data and reads the recorded image data from the recording medium 140. Note that the recording medium 140 may be a built-in recording medium.

### Crop Function and Enlarged Display Function

It is assumed that the digital camera 100 has a crop function and an enlarged display function.

The crop function is a function of cutting out (extracting) an area (a crop area) of an arbitrary position and size from a captured image (an image captured by the imaging unit 104). An area is cut out by the image processing unit 106. In the crop function, the image of the cut-out area can be displayed on the display unit 110, can be displayed on an external display device (not illustrated), or can be saved in the recording medium 140. The digital camera 100 (the system control unit 120) can superimpose a frame indicating the cut-out area on the captured image and can display the frame on the display unit 110. Hereinafter, the area cut out by the crop function is referred to as a crop area, and the frame indicating the crop area is referred to as a crop frame.

The enlarged display function is a function of enlarging a captured image at an arbitrary magnification and displaying the enlarged captured image on the display unit 110 (a function of enlarging a partial area of the captured image and displaying the enlarged captured image on the display unit 110). It is possible to confirm the captured image in more detail by enlarging the captured image. The enlarged display function can be executed by a function button included in the operation unit 129. The system control unit 120 receives an input signal from the function button, and performs enlarged display start processing or enlargement ratio change processing.

Although details will be described later, in the present embodiment, the digital camera 100 (the system control unit 120) displays a direction indicator indicating a direction toward the crop area on the display unit 110 or the external display device (not illustrated) during enlarged display. Furthermore, the digital camera 100 (the system control unit 120) sets (switches) whether to display the direction indicator during the enlarged display in accordance with an instruction from the user. The user can perform this instruction from the menu screen. The digital camera 100 (the system control unit 120) stores a set value as to whether to display the direction indicator during the enlarged display in the non-volatile memory 136, and updates the set value in response to an instruction from the user.

The digital camera 100 has a function by digital image processing and a function by optical processing as enlarged display functions. The digital image processing is processing performed by the image processing unit 106, and the optical processing is processing of driving the shooting lens 103 (zoom lens). For example, the main application of the enlarged display function by the digital image processing is confirmation of the focus of the captured image, and in the enlarged display function, confirmation in the crop area is important. On the other hand, a main application of the enlarged display function by the optical processing is shooting of an object with a large size, and in the enlarged display function, confirmation in the crop area is not important. Therefore, the enlarged display function to be described later is assumed to be an enlarged display function by digital image processing. Hereinafter, an area enlarged and displayed by the enlarged display function is referred to as an enlarged area.

### Display Screen

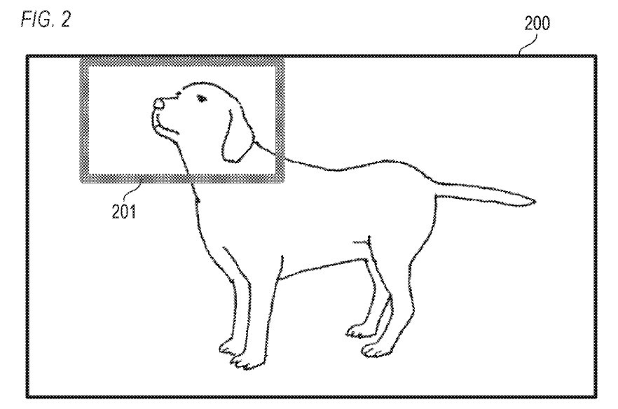

A screen displayed on the display unit 110 when at least one of the crop function and the enlarged display function is executed will be described with reference to FIGS. 2-7F.

FIG. 2 illustrates a display screen 200 when the crop function is executed. On the display screen 200, a crop frame 201 is displayed and superimposed on a captured image. When the user operates the touch panel 130 or the direction keys 131 included in the operation unit 129, the system control unit 120 receives an input signal from the operation unit 129 and sets (determines, changes) the position of the crop frame 201 (crop area) in response to the input signal. The system control unit 120 can also set (determine, change) the size of the crop frame 201 (crop area) in response to the input signal from the operation unit 129. The system control unit 120 stores the set values of the position and size of the crop frame 201 (crop area) in the non-volatile memory 136, and updates the stored set values in response to an instruction from the user. In this manner, the user can arbitrarily change the position and size of the crop frame 201 (crop area).

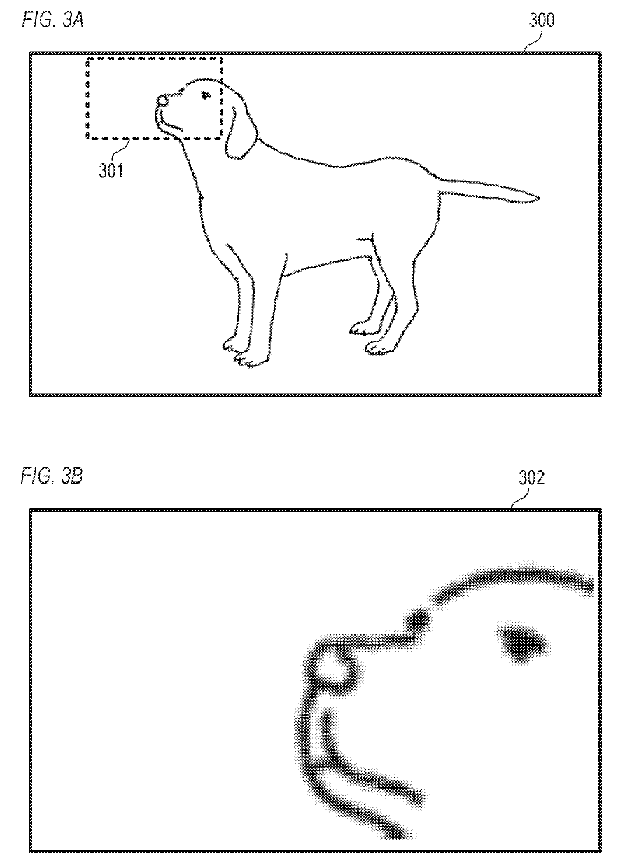

FIGS. 3A and 3B illustrate display screens during execution of the enlarged display function.

A display screen 300 in FIG. 3A is a screen before enlargement (enlarged display), and the entire captured image is displayed on the display screen 300. An area 301 is an enlarged area. When the user operates the touch panel 130 or the direction keys 131 included in the operation unit 129, the system control unit 120 receives an input signal from the operation unit 129 and sets (determines, changes) the position of the enlarged area 301 in response to the input signal. The system control unit 120 can also set (determine, change) the size of the enlarged area 301 in response to the input signal from the operation unit 129. In the present embodiment, the image in the enlarged area 301 is displayed in a predetermined area (for example, the entire screen) by the enlarged display function. Therefore, the size of the enlarged area 301 corresponds to an enlargement ratio. The system control unit 120 stores the set values of the position and size of the enlarged area 301 in the non-volatile memory 136, and updates the stored set values in response to the instruction from the user. In this manner, the user can arbitrarily change the position and size of the enlarged area 301.

A display screen 302 in FIG. 3B is a screen being enlarged (enlarged display), and the enlarged area 301 in FIG. 3A is enlarged and displayed on the display screen 302.

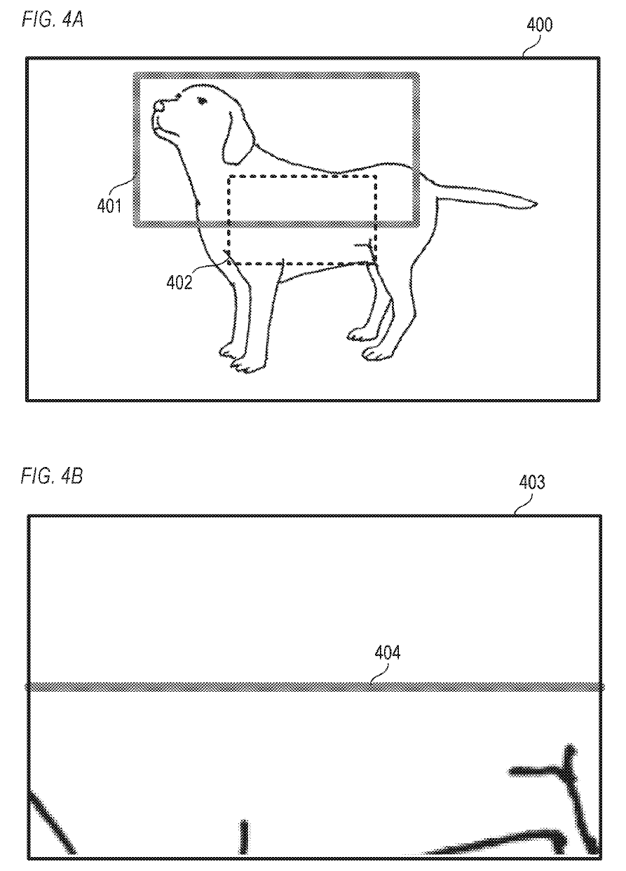

FIGS. 4A and 4B illustrate display screens when both the crop function and the enlarged display function are simultaneously used.

A display screen 400 in FIG. 4A is a screen before enlargement (enlarged display), and the entire captured image is displayed on the display screen 400. A frame 401 is a crop frame, and an area 402 is an enlarged area. The enlarged area 402 includes only a part (lower side portion) of the crop frame 401.

A display screen 403 in FIG. 4B is a screen being enlarged (enlarged display), and the enlarged area 402 in FIG. 4A is enlarged and displayed on the display screen 403. A line 404 in FIG. 4B is a portion (lower side portion) included in the enlarged area 402 in the crop frame 401 in FIG. 4A.

When both the crop function and the enlarged display function are used simultaneously, the crop frame may not be displayed on the screen, or only a part of the crop frame may be displayed on the screen, as illustrated in FIG. 4B. In this case, the user takes time to find the crop frame (crop area) or misunderstands the crop area, so that the focus in the crop area cannot be smoothly confirmed. For example, on the display screen 403 in FIG. 4B, the user cannot easily grasp whether the upper side of the line 404 is the crop area or the lower side of the line 404 is the crop area. Therefore, in the present embodiment, as described above, the direction indicator indicating the direction toward the crop area is displayed.

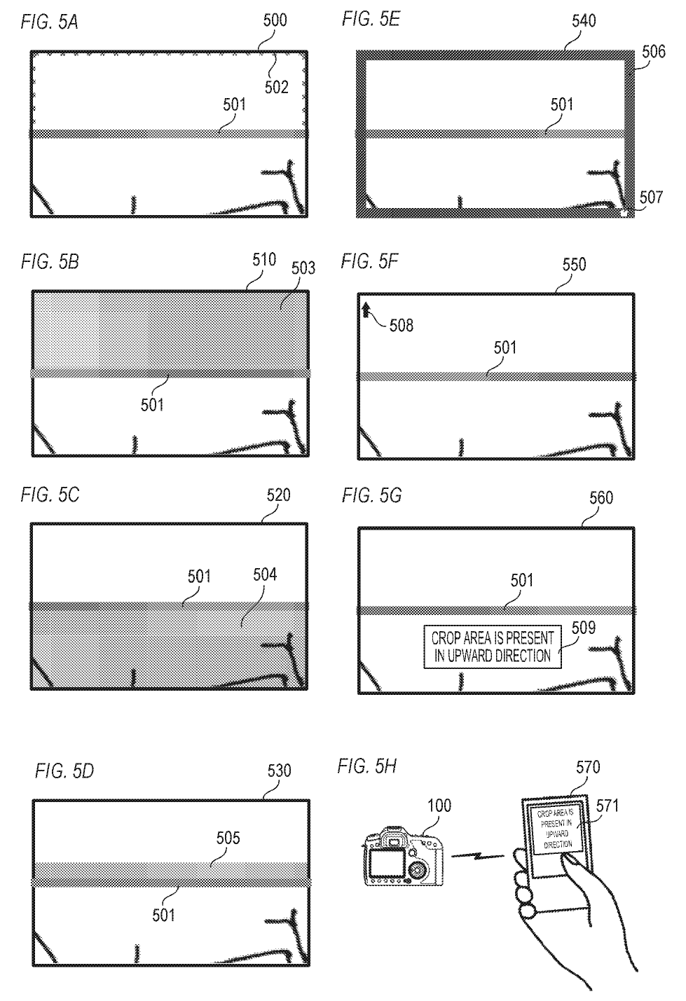

FIGS. 5A-5H illustrate display screens that display direction indicators indicating directions toward the crop area. The direction indicator is displayed under the control of the system control unit 120. Similarly to FIG. 4B, the display screens of FIGS. 5A-5G are enlarged (enlarged display). In the display screens of FIGS. 5A-5G, a line 501 which is a part of the crop frame is displayed, similarly to FIG. 4B.

On a display screen 500 in FIG. 5A, a dotted line 502 is displayed as a direction indicator. The dotted line 502 is displayed along the portion on the side of the crop area in the edge (outline) of the enlarged area. The portion on the side of the crop area may be interpreted as a portion included in the crop area. Note that the position, number, and the like of the dotted line are not particularly limited as long as the direction toward the crop area is indicated. For example, the dotted line may be displayed along a portion other than the portion on the side of the crop area in the edge of the enlarged area, or may be displayed inside the enlarged area.

On a display screen 510 in FIG. 5B, a mask 503 that covers the entire crop area is displayed as a direction indicator. Here, the crop area may be interpreted as a portion included in the enlarged area in the crop area.

On a display screen 520 in FIG. 5C, a mask 504 that covers the entire area excluding the crop area is displayed as a direction indicator. Here, the outside of the crop area may be interpreted as a portion included in the enlarged area outside the crop area.

On a display screen 530 in FIG. 5D, a mask 505 that covers a part of the crop area is displayed as a direction indicator. As the mask 505, a rectangular mask in contact with the entire line 501 (a part of the crop frame) is displayed, but the shape and position of the mask are not particularly limited as long as the direction toward the crop area is indicated. For example, the mask may be displayed at a position away from the crop frame, or may cover a part outside the crop area.

On the display screen 540 in FIG. 5E, a mask 506 (frame) surrounding the enlarged area is displayed under the control of the system control unit 120. In order to display the mask 506, the enlarged area is reduced and displayed. Then, as a direction indicator, an icon 507 is displayed superimposed on the mask 506. As the icon 507, an arrow icon is displayed in the lower right portion of the mask, but the design and position of the icon are not particularly limited as long as the direction toward the crop area is indicated.

On the display screen 550 in FIG. 5F, a mask surrounding the enlarged area is not displayed, and an icon 508 is displayed as a direction indicator so as to be superimposed on the captured image (enlarged area). As described above, the design and position of the icon are not particularly limited.

On the display screen 560 in FIG. 5G, a message 509 is displayed as a direction indicator. Note that a content of the message is not particularly limited as long as the direction toward the crop area is indicated.

In FIG. 5H, the digital camera 100 (the system control unit 120) displays a message 571 as a direction indicator on an external terminal 570 (an external device) via the communication unit 123. As described above, the content of the message is not particularly limited. The direction indicator displayed on the external device is not limited to the message. Any of the display screens in FIGS. 5A-5G may be displayed on the external device.

Note that, in the present embodiment, any of the eight directions of the upward direction, the upper right direction, the right direction, the lower right direction, the downward direction, the lower left direction, the left direction, and the upper left direction is indicated by the direction indicator, but the direction indicated by the direction indicator is not limited thereto. The number of directions indicated by the direction indicator may be more or less than eight.

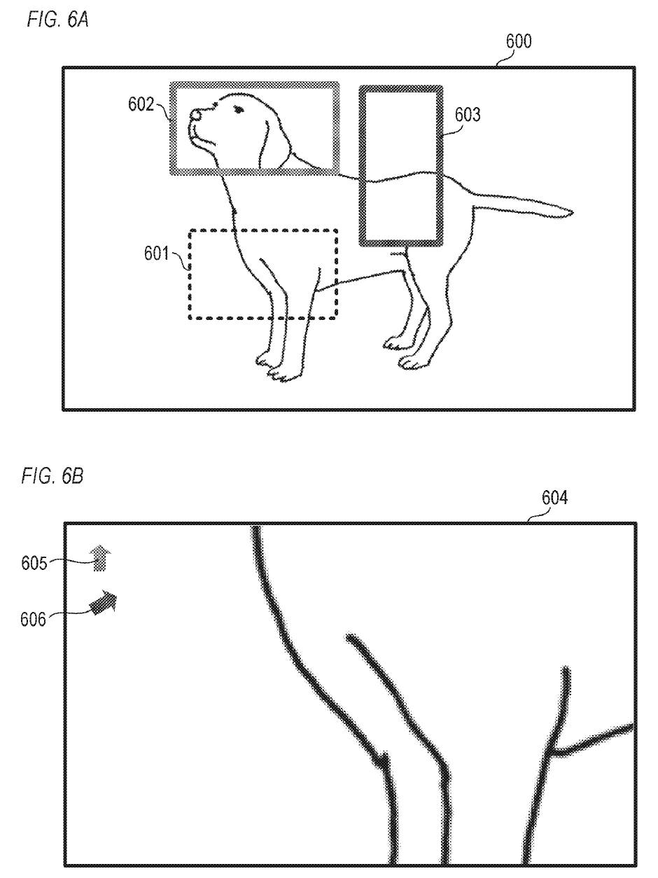

FIGS. 6A and 6B illustrate display screens when both the crop function and the enlarged display function are used at the same time.

A display screen 600 in FIG. 6A is a screen before enlargement (enlarged display), and the entire captured image is displayed on the display screen 600. An area 601 is an enlarged area, a frame 602 is a first crop frame, and a frame 603 is a second crop frame. The number of crop frames (crop areas) is not particularly limited, and may be more or less than two. The enlarged area 601, the first crop frame 602, and the second crop frame 603 are spaced apart from one another, and the enlarged area 601 does not include the first crop frame 602 or the second crop frame 603.

A display screen 604 in FIG. 6B is a screen being enlarged (enlarged display), and the enlarged area 601 in FIG. 6A is enlarged and displayed on the display screen 604. Since the first and second crop frames 602 and 603 are not included in the enlarged area 601, neither the first crop frame 602 nor the second crop frame 603 is displayed on the display screen 604. In the present embodiment, when there are a plurality of crop frames (a plurality of crop areas), a plurality of direction indicators respectively corresponding to the plurality of crop frames (a plurality of crop areas) are displayed during enlarged display. On the display screen 604, an icon 605 (an arrow icon indicating the upward direction) is displayed as a direction indicator indicating a direction toward the first crop frame 602. Then, an icon 606 (an arrow icon indicating the upper right direction) is displayed as a direction indicator indicating a direction toward the second crop frame 603. Note that the plurality of direction indicators indicating the plurality of directions to the plurality of crop frames are not particularly limited. As each direction indicator, a direction indicator similar to any of the direction indicators in FIGS. 5A-5H may be displayed.

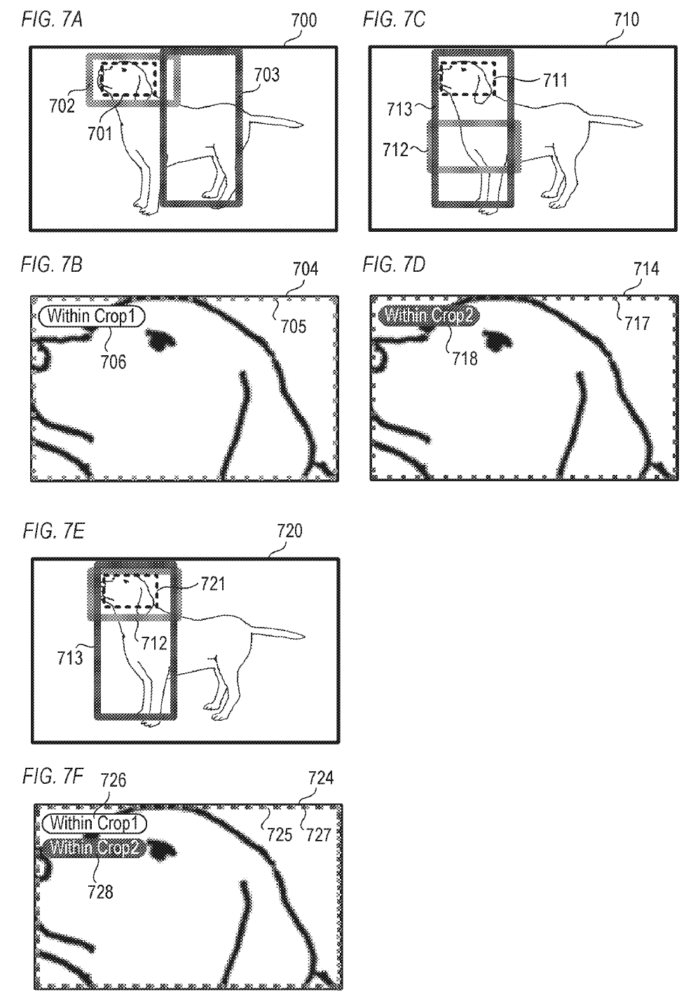

FIGS. 7A-7F illustrate display screens when both the crop function and the enlarged display function are simultaneously used.

A display screen 700 in FIG. 7A is a screen before enlargement (enlarged display), and the entire captured image is displayed on the display screen 700. An area 701 is an enlarged area, a frame 702 is a first crop frame, and a frame 703 is a second crop frame. The enlarged area 701 is surrounded by the first crop frame 702, and the entire enlarged area 701 is included in the crop area of the first crop frame 702. In addition, the enlarged area 701 and the second crop frame 703 are separated from each other. Therefore, the enlarged area 701 does not include the first crop frame 702 or the second crop frame 703.

A display screen 704 in FIG. 7B is a screen being enlarged (enlarged display), and the enlarged area 701 in FIG. 7A is enlarged and displayed on the display screen 704. Since the first and second crop frames 702 and 703 are not included in the enlarged area 701, neither the first crop frame 702 nor the second crop frame 703 is displayed on the display screen 704. In the present embodiment, when the entire enlarged area is included in the crop area, an inclusion indicator indicating that the entire enlarged area is included in the crop area is displayed during enlarged display under the control of the system control unit 120. On the display screen 704, a dotted line 705 is displayed as a direction indicator indicating the direction toward the first crop frame 702. Further, an icon 706 is displayed as an inclusion indicator indicating that the entire enlarged area 701 is included in the crop area of the first crop frame 702 (the enlarged area 701 is surrounded by the first crop frame 702).

In FIG. 7B, a direction indicator indicating a direction toward the second crop frame 703 may be further displayed. When the icon 706 (the inclusion indicator indicating that the entire enlarged area 701 is included in the crop area of the first crop frame 702) is displayed, the dotted line 705 (the direction indicator indicating the direction toward the first crop frame 702) may not be displayed. The direction indicator is not particularly limited. A direction indicator similar to any of the direction indicators in FIGS. 5A-5H may be displayed. The inclusion indicator is also not particularly limited.

A display screen 710 in FIG. 7C is a screen before enlargement (enlarged display), and the entire captured image is displayed on the display screen 710. An area 711 is an enlarged area, a frame 712 is a first crop frame, and a frame 713 is a second crop frame. The enlarged area 711 is surrounded by the second crop frame 713, and the entire enlarged area 711 is included in the crop area of the second crop frame 713. In addition, the enlarged area 711 and the first crop frame 712 are separated from each other. Therefore, the enlarged area 711 does not include the first crop frame 712 or the second crop frame 713.

A display screen 714 in FIG. 7D is a screen being enlarged (enlarged display), and the enlarged area 711 in FIG. 7C is enlarged and displayed on the display screen 714. Since the first and second crop frames 712 and 713 are not included in the enlarged area 711, neither the first crop frame 712 nor the second crop frame 713 is displayed on the display screen 714. On the display screen 714, a dotted line 717 is displayed as a direction indicator indicating the direction toward the second crop frame 713. Further, an icon 718 is displayed as an inclusion indicator indicating that the entire enlarged area 711 is included in the crop area of the second crop frame 713 (the enlarged area 711 is surrounded by the second crop frame 713).

In FIG. 7D, a direction indicator indicating a direction toward the first crop frame 712 may be further displayed. When the icon 718 (the inclusion indicator indicating that the entire enlarged area 711 is included in the crop area of the second crop frame 713) is displayed, the dotted line 717 (the direction indicator indicating the direction toward the second crop frame 713) may not be displayed. The indicator is not particularly limited. A direction indicator similar to any of the direction indicators in FIGS. 5A-5H may be displayed. The inclusion indicator is also not particularly limited.

A display screen 720 in FIG. 7E is a screen before enlargement (enlarged display), and the entire captured image is displayed on the display screen 720. An area 721 is an enlarged area, a frame 722 is a first crop frame, and a frame 723 is a second crop frame. The enlarged area 721 is surrounded by the first crop frame 722, and is also surrounded by the second crop frame 723. Therefore, the enlarged area 721 does not include the first crop frame 722 or the second crop frame 723.

A display screen 724 in FIG. 7F is a screen being enlarged (enlarged display), and the enlarged area 721 in FIG. 7E is enlarged and displayed on the display screen 724. Since the first and second crop frames 722 and 723 are not included in the enlarged area 721, neither the first crop frame 722 nor the second crop frame 723 is displayed on the display screen 724. In the present embodiment, when a plurality of crop areas exist and the entire enlarged area is included in all of the plurality of crop areas, a plurality of inclusion indicators respectively corresponding to the plurality of crop areas are displayed during enlarged display. On the display screen 724, a dotted line 725 is displayed as a direction indicator indicating the direction toward the first crop frame 722, and a dotted line 727 is displayed as a direction indicator indicating the direction toward the second crop frame 723. Further, an icon 726 is displayed as an inclusion indicator indicating that the entire enlarged area 721 is included in the crop area of the first crop frame 722 (the enlarged area 721 is surrounded by the first crop frame 722). Then, an icon 728 is displayed as an inclusion indicator indicating that the entire enlarged area 721 is included in the crop area of the second crop frame 723 (the enlarged area 721 is surrounded by the second crop frame 723).

When the icon 726 (the inclusion indicator indicating that the entire enlarged area 721 is included in the crop area of the first crop frame 722) is displayed, the dotted line 725 (the direction indicator indicating the direction toward the first crop frame 722) may not be displayed. Similarly, when the icon 728 (the inclusion indicator indicating that the entire enlarged area 721 is included in the crop area of the second crop frame 723) is displayed, the dotted line 727 (the direction indicator indicating the direction toward the second crop frame 723) may not be displayed. The direction indicator is not particularly limited. A direction indicator similar to any of the direction indicators in FIGS. 5A-5H may be displayed. The inclusion indicator is also not particularly limited.

In addition, the sizes of the direction indicator and the inclusion indicator may change depending on the enlargement ratio of the enlarged display, but in the present embodiment, the system control unit 120 does not change the sizes of the direction indicator and the inclusion indicator even if the enlargement ratio is changed.

### Operation

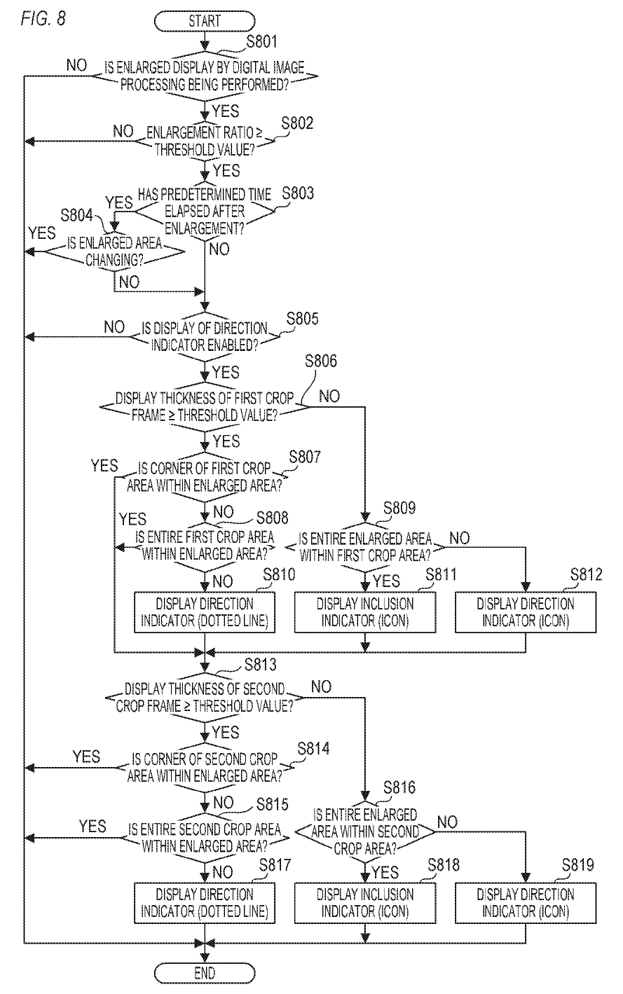

FIG. 8 is a flowchart illustrating an operation of the digital camera 100. An operation in FIG. 8 is implemented by loading a program recorded in the non-volatile memory 136 into the system memory 121 and executing the program by the system control unit 120. For example, when the digital camera 100 is activated, the operation in FIG. 8 is started. The operation in FIG. 8 is repeated at a predetermined cycle. The number of crop areas is not particularly limited, but it is assumed here that two crop areas (a first crop area and a second crop area) are set. Furthermore, the thickness of the crop frame is not particularly limited, but here, it is assumed that the thickness of the crop frame is 2 pixels.

In S801, the system control unit 120 determines whether enlarged display by digital image processing is being performed. When the enlarged display by the digital image processing is being performed, the processing proceeds to S802, and when the enlarged display is not being performed, the operation in FIG. 8 ends.

In step S802, the system control unit 120 determines whether the enlargement ratio of the enlarged display is equal to or greater than a predetermined value. After the enlarged display is started and the enlargement ratio is changed, the system control unit 120 determines whether a ratio of the enlargement ratio after the change to the enlargement ratio before the change (a change ratio of the enlargement ratio) is equal to or greater than a predetermined value. The predetermined value is not particularly limited, and is, for example, 1.5 times. When the enlargement ratio (change ratio of the enlargement ratio) is equal to or greater than the predetermined value, the processing proceeds to S803, and when the enlargement ratio is not equal to or greater than the predetermined value, the operation in FIG. 8 ends. In the present embodiment, information on the enlargement ratio before the change and the enlargement ratio after the change is stored in the system memory 121. The system control unit 120 makes the determination in S802 with reference to the information stored in the system memory 121.

In S803, the system control unit 120 uses the system timer 122 to determine whether a predetermined time has elapsed since the enlarged display was started. After the enlarged display is started and the enlargement ratio is changed, the system control unit 120 determines whether a predetermined time has elapsed since the enlargement ratio was changed. The predetermined time is not particularly limited, and is, for example, 5 seconds. When the predetermined time has elapsed since the enlarged display was started (since the enlargement ratio was changed), the processing proceeds to S804, and when the predetermined time has not elapsed since the enlarged display was started, the processing proceeds to S805.

In S804, the system control unit 120 determines whether the enlarged area is being changed (for example, during the movement of the enlarged area) based on an input signal from the operation unit 129. When the enlarged area is being changed, the operation in FIG. 8 ends, and when the enlarged area is not being changed, the processing proceeds to S805.

In S805, the system control unit 120 refers to a set value of the menu stored in the non-volatile memory 136, and determines whether setting for displaying a direction indicator during the enlarged display is enabled. When the setting for displaying the direction indicator during the enlarged display is enabled, the processing proceeds to S806, and when the setting for displaying the direction indicator during the enlarged display is not enabled, the operation in FIG. 8 ends.

In the present embodiment, the type of direction indicator is changed depending on whether a thickness of a portion included in the enlarged area in the crop frame is equal to or greater than a predetermined value. In S806, the system control unit 120 determines whether a display thickness of a first crop frame corresponding to a first crop area (a thickness of a portion included in the enlarged area (a displayed portion) in the first crop frame) is equal to or greater than a predetermined value. The predetermined value is not particularly limited, and is, for example, the thickness (2 pixels) of the first crop frame. When the display thickness of the first crop frame is equal to or greater than the predetermined value, the processing proceeds to S807, and when the display thickness of the first crop frame is not equal to or greater than the predetermined value, the processing proceeds to S809.

In S807, the system control unit 120 determines whether the corner of the first crop area is located within the enlarged area (whether the corner of the first crop frame is displayed). This determination is made with reference to the set values of the position and size of the first crop area and the set values of the position and size of the enlarged area stored in the non-volatile memory 136. When the corner of the first crop area is located in the enlarged area, the processing proceeds to S813, and when the corner of the first crop area is not located in the enlarged area, the processing proceeds to S808.

In S808, the system control unit 120 determines whether the entire first crop area is included in the enlarged area (whether the entire first crop frame is displayed). This determination is made with reference to the set values of the position and size of the first crop area and the set values of the position and size of the enlarged area stored in the non-volatile memory 136. When the entire first crop area is included in the enlarged area, the processing proceeds to S813, and when the entire first crop area is not included in the enlarged area, the processing proceeds to S810.

In S809, the system control unit 120 determines whether the entire enlarged area is included in the first crop area. This determination is made with reference to the set values of the position and size of the first crop area and the set values of the position and size of the enlarged area stored in the non-volatile memory 136. When the entire enlarged area is included in the first crop area, the processing proceeds to S811, and when the entire enlarged area is not included in the first crop area, the processing proceeds to S812.

In S810, the system control unit 120 displays a dotted line on the display unit 110 as a direction indicator indicating the direction toward the first crop area.

In S811, the system control unit 120 displays an icon on the display unit 110 as an inclusion indicator indicating that the entire enlarged area is included in the first crop area.

In S812, the system control unit 120 displays an icon on the display unit 110 as a direction indicator indicating the direction toward the first crop area.

In S813, the system control unit 120 determines whether a display thickness of a second crop frame corresponding to a second crop area (a thickness of a portion included in the enlarged area (a displayed portion) in the second crop frame) is equal to or greater than a predetermined value. The predetermined value is not particularly limited, and is, for example, the thickness (2 pixels) of the second crop frame. When the display thickness of the second crop frame is equal to or greater than the predetermined value, the processing proceeds to S814, and when the display thickness of the second crop frame is not equal to or greater than the predetermined value, the processing proceeds to S816.

In S814, the system control unit 120 determines whether the corner of the second crop area is located within the enlarged area (whether the corner of the second crop frame is displayed). This determination is made with reference to the set values of the position and size of the second crop area and the set values of the position and size of the enlarged area stored in the non-volatile memory 136. When the corner of the second crop area is located within the enlarged area, the operation in FIG. 8 ends, and when the corner of the second crop area is not located within the enlarged area, the processing proceeds to S815.

In S815, the system control unit 120 determines whether the entire second crop area is included in the enlarged area (whether the entire second crop frame is displayed). This determination is made with reference to the set values of the position and size of the second crop area and the set values of the position and size of the enlarged area stored in the non-volatile memory 136. When the entire second crop area is included in the enlarged area, the operation in FIG. 8 ends, and when the entire second crop area is not included in the enlarged area, the processing proceeds to S817.

In S816, the system control unit 120 determines whether the entire enlarged area is included in the second crop area. This determination is made with reference to the set values of the position and size of the second crop area and the set values of the position and size of the enlarged area stored in the non-volatile memory 136. When the entire enlarged area is included in the second crop area, the processing proceeds to S818, and when the entire enlarged area is not included in the second crop area, the processing proceeds to S819.

In S817, the system control unit 120 displays a dotted line on the display unit 110 as a direction indicator indicating the direction toward the second crop area.

In S818, the system control unit 120 displays an icon on the display unit 110 as an inclusion indicator indicating that the entire enlarged area is included in the second crop area.

In S819, the system control unit 120 displays an icon on the display unit 110 as a direction indicator indicating the direction toward the second crop area.

As described above, according to the present embodiment, the indicator indicating the direction toward the crop area is displayed during the enlarged display. This allows the user to quickly and accurately find the crop area.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment. For example, the present disclosure is applicable not only to a digital camera but also to various electronic devices such as a smartphone, a tablet terminal, and a personal computer. The image to be displayed is not limited to the captured image, and may be an illustration or the like.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-070117, filed Apr. 22, 2025, which is hereby incorporated by reference herein in its entirety.

What is claimed is:

1. An electronic device comprising:
a processor; and
a memory storing a program which, when executed by the processor, causes the electronic device to execute display control processing of performing control to display a crop frame indicating a crop area, which is an area to be cut out from an image, by superimposing the crop frame on the image,
wherein, in the display control processing,
control is executable to perform enlarged display of enlarging and displaying an enlarged area, which is a partial area of the image, and
control is performed to display a first indicator indicating a direction toward the crop area during the enlarged display.

2. The electronic device according to claim 1, wherein
the first indicator is any of a dotted line, a mask covering entire of the crop area, a mask covering entire of an area excluding the crop area, and a mask covering a part of the crop area.

3. The electronic device according to claim 1, wherein
the first indicator is an icon.

4. The electronic device according to claim 3, wherein, in the display control processing,
control is performed to display a mask surrounding the enlarged area during the enlarged display, and
control is performed to display the icon superimposed on the mask.

5. The electronic device according to claim 1, wherein
the first indicator is a message.

6. The electronic device according to claim 1, wherein
in the display control processing, control is performed to display the first indicator on an external device.

7. The electronic device according to claim 1, wherein
directions indicatable by the first indicator are eight directions.

8. The electronic device according to claim 1, wherein
in the display control processing, in a case where a corner of the crop area is located in the enlarged area, control is performed so as not to display the first indicator.

9. The electronic device according to claim 1, wherein
in the display control processing, in a case where there are a plurality of crop areas, control is performed to display a plurality of first indicators respectively corresponding to the plurality of crop areas during the enlarged display.

10. The electronic device according to claim 1, wherein
in the display control processing, control is performed so as not to display the first indicator in a case where a predetermined time has elapsed since the enlarged display was started and the enlarged area is not being changed.

11. The electronic device according to claim 1, wherein
in the display control processing, a size of the first indicator is not changed even if an enlargement ratio of the enlarged display is changed.

12. The electronic device according to claim 1, wherein
in the display control processing, a type of the first indicator is changed depending on whether a thickness of a portion included in the enlarged area in the crop frame is equal to or greater than a predetermined value.

13. The electronic device according to claim 1, wherein
in the display control processing, control is performed such that the first indicator is not displayed in a case where an enlargement ratio of the enlarged display is smaller than a predetermined value.

14. The electronic device according to claim 1, wherein
in the display control processing, in a case where entire of the crop area is included in the enlarged area, control is performed so as not to display the first indicator.

15. The electronic device according to claim 1, wherein
the enlarged display is enlarged display by digital image processing.

16. The electronic device according to claim 1, wherein
when the program is executed by the processor, the program further causes the electronic device to execute, in response to an instruction from a user, setting processing of setting whether to display the first indicator during the enlarged display.

17. The electronic device according to claim 1, wherein
in the display control processing, in a case where entire of the enlarged area is included in the crop area, control is performed to display a second indicator indicating that the entire of the enlarged area is included in the crop area during the enlarged display.

18. The electronic device according to claim 17, wherein
in the display control processing, in a case where there are a plurality of crop areas are present and entire of the enlarged area is included in all of the plurality of crop areas, control is performed to display a plurality of second indicators respectively corresponding to the plurality of crop areas during the enlarged display.

19. A control method of an electronic device, comprising:
performing control to display a crop frame indicating a crop area, which is an area to be cut out from an image, by superimposing the crop frame on the image;
performing control to perform enlarged display of enlarging and displaying an enlarged area, which is a partial area of the image; and
performing control to display a first indicator indicating a direction toward the crop area during the enlarged display.

20. A non-transitory computer readable medium that stores a program, wherein the program causes a computer to execute a control method of an electronic device, the control method comprising:
performing control to display a crop frame indicating a crop area, which is an area to be cut out from an image, by superimposing the crop frame on the image;
performing control to perform enlarged display of enlarging and displaying an enlarged area, which is a partial area of the image; and
performing control to display a first indicator indicating a direction toward the crop area during the enlarged display.
